(19) United States
(12) Patent Application Publication
(10) Pub. No.: US 2016/0245950 A1
(43) Pub. Date: Aug. 25, 2016

(54) USING REPRESENTATIVE ELEMENTAL VOLUME TO DETERMINE SUBSET VOLUME IN AN AREA OF INTEREST EARTH MODEL

(71) Applicant: LANDMARK GRAPHICS CORPORATION, Houston, TX (US)

(72) Inventor: Travis Ramsay, Katy, TX (US)

(21) Appl. No.: 14/909,128

(22) PCT Filed: Oct. 14, 2014
(86) PCT No.: PCT/US2014/060399

§ 371 Date: Jan. 31, 2016

(51) Int. Cl. G01V 99/00; G06T 17/20; G06T 17/05; G01N 15/08

(52) U.S. Cl. CPC G01V 99/005; G01N 15/088; G06T 17/20; G06T 17/05

(57) ABSTRACT

Method for determining a subset volume in a 3D geocellular model of an oil and gas reservoir includes creating a 3D geocellular grid of the reservoir, defining a thick cross section for an area of interest within the 3D geocellular grid, iteratively increasing the volume of the thick cross section by a predetermined number of cells on each side, moving the thick cross section throughout the 3D geocellular grid, and performing a representative elemental volume (REV) analysis based on porosity for the resulting thick cross section. One embodiments allow incorporating REV analysis to determine a subset reservoir model volume which is smaller than the full field model but representative of the petrophysical property distribution in the full field model. This is done so that subset models act as theoretical proxies to the full field models and allow more detailed analysis before building the full field model.

### TECHNICAL FIELD

The embodiments disclosed herein relate generally to the field of petroleum reservoir exploitation, and more particularly, to systems and methods for using a representative elemental volume (“REV”) for the determination of a subset volume to build an area of interest reservoir model of similar condition with respect to the full field model.

### BACKGROUND

Many factors may affect the development of oil and gas fields. To increase the production and profitability of an oil and gas field, reservoir simulation models are generated to allow reservoir engineers to plan and manage the fields. Creating full field models of reservoirs is a difficult and time consuming task. There is a need for reservoir models that are simpler and less time consuming than full field models, yet will yield scalable fluid conductivities and rock property connectivities which are representative of the final model. This would allow for better decision making capability for the modeler before he or she is required to execute the full field model.

### BRIEF DESCRIPTION OF THE DRAWINGS

FIG. 1 is a diagram illustrating a work flow according to an embodiment of the disclosure.

FIG. 2 is a diagram illustrating the determination of an REV with respect to porosity and scale length of an examination window according to an embodiment of the disclosure.

FIG. 3 is a diagram of a system for performing a determination of an REV according to an embodiment.

### DETAILED DESCRIPTION OF DISCLOSED EMBODIMENTS

As an initial matter, it will be appreciated that the development of an actual, real commercial application incorporating aspects of the disclosed embodiments will require many implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would nevertheless be a routine undertaking for those of skill in this art having the benefit of this disclosure.

It should also be understood that the embodiments disclosed and taught herein are susceptible to numerous and various modifications and alternative forms. Thus, the use of a singular term, such as, but not limited to, “a” and the like, is not intended as limiting of the number of items. Similarly, any relational terms, such as, but not limited to, “top,” “bottom,” “left,” “right,” “upper,” “lower,” “down,” “up,” “side,” and the like, used in the written description are for clarity in specific reference to the drawings and are not intended to limit the scope of the disclosure.

As mentioned above, the embodiments disclosed herein relate to systems and methods for using a representative elemental volume (“REV”) for the determination of a subset volume to build an area of interest reservoir model. Example implementations of the disclosed embodiments may use information generated by a suitable oilfield modeling software. An example of suitable oilfield modeling software includes the DecisionSpace® Earth Modeling application, which is a module of the DecisionSpace® Geosciences suite, available from Halliburton Energy Services, Inc. The DecisionSpace® Earth Modeling application is a subsurface tool that integrates subsurface data from well logs, cores, and seismic surveys, along with qualitative data to construct a 3D representation of a reservoir. It may also use both stochastic and deterministic approaches to create a geocellular model of a reservoir. The DecisionSpace® Earth Modeling application, and other suitable applications, may produce a two-dimensional (2D) or three-dimensional (3D) geocellular grid containing various distributed petrophysical properties required by a numerical flow simulation model according to an embodiment, such as porosity, permeability, net-to-gross, and so forth. These properties may be stored at the center of each cell for 3D grids (cell-centered). The grid rotation may be based on the geological definition of azimuth, where zero degrees represents North. The grid azimuth is defined as 0 degrees plus or minus the rotation value. The geocellular grid may be stored in computer memory using, for example, the VDB storage format.

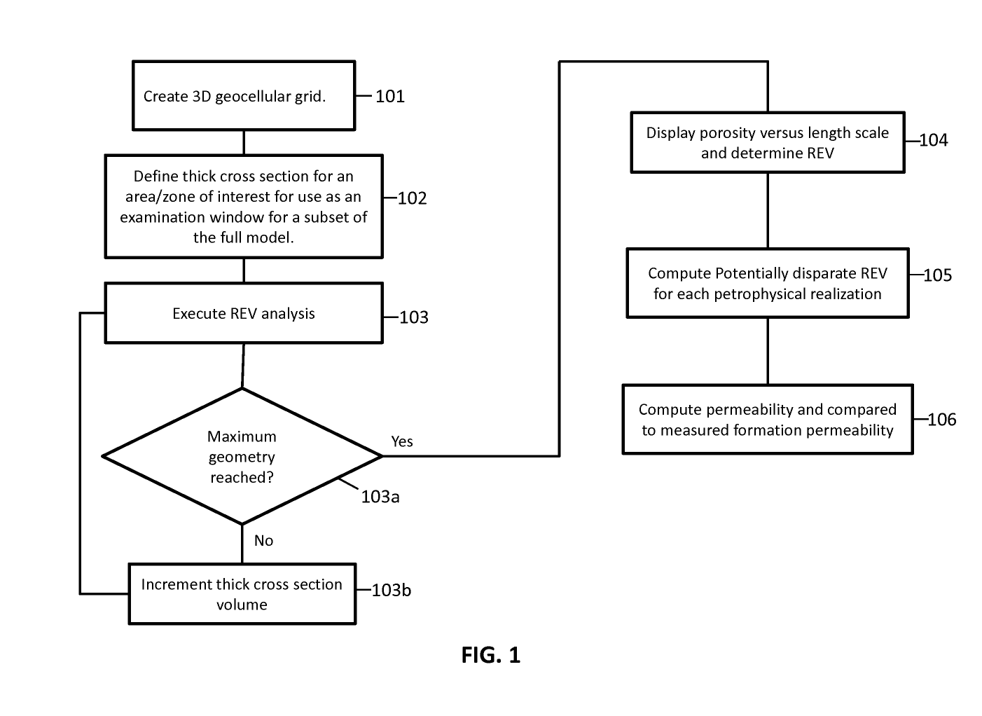

In one or more embodiments, a method for determining a subset volume in a 3D geocellular model of an oil and gas reservoir using representative elemental volume (REV) analysis is disclosed. FIG. 1 is a flow chart illustrating an embodiment of the disclosed method. The method may begin with the creation of a 3D geocellular grid of the reservoir as shown in step 101. The full model of the reservoir will include all the cells created in the 3D geocellular model, while extracting a subset grid volume from the full scale grid volume is described in more detail in steps 102-106 of FIG. 1.

In step 102, a thick cross section for an area of interest may be defined to act as an examination window. The thick cross section or fence diagram, is a subset of the full model and may have a predetermined initial number of cells. The shape of the thick cross-section may be cubic, with the same number of geocells in each direction along each of the X, Y, and Z axes, or it may be rectangular, with a different number of cells along one or more axes. Therefore, the shape and size of the initial thick cross-section is arbitrary and subject to the design choice of the oil field practitioner. However, it cannot exceed, along any particular axis, the corresponding dimension of the full model. The geometry of the thick cross-section may be defined in void space, in which the only information contained in the 3D geocells in the thick cross-section is information about the grid itself plus information specifying controls on the location. The information in the thick cross-section or fence diagram includes the minimum number of cells that comprise the examination window, i.e., the number of cells in each of the X, Y, and Z axis directions, and the number of cells -n-, where the value -n- may be unique for each individual axis, to increase each length scale for successive REV analysis.

The other information that may be provided in the geometry of the thick cross-section may include the identity of the specific wells that are to be included in the thick cross-section. By identifying specific wells as a spatial constraint, the location of the thick cross section would be restricted to the specific area in the geocellular grid which encompasses the selected user area as an examination window; however the REV analysis would allow the subset volume to increase in accordance with the determination/verification of REV for the subset volume. Other embodiments may specify the thick cross section by the number of wells to include in the thick cross-section and the minimum amount of cells that comprise the thick cross section, which serves as an examination window. This allows the examination window to be moved during the REV analysis to different locations in the geocellular grid, allowing the practitioner to determine how changes in the location of the examination window may affect the determination of a REV. A method, according to an embodiment of the disclosure, seeks to use REV analysis to assess the porosity in the construed examination window. The well log attributes to include in the thick cross-section are input to the deterministic or stochastic modeling algorithms in order to calculate porosity and permeability of the reservoir.

In step 103, an REV analysis is performed with respect to porosity for the thick cross section. Successive petrophysical simulations may be generated and the resulting models preserve the same statistical solution as would be seen in the final model. The REV analysis may use an REV algorithm based on the initial thick cross-section defined according to the constraints in step 102 with porosity assigned to the geocellular grid as a result of deterministic or stochastic modeling. The REV analysis in steps 103-103b is iterative. In the first iteration, petrophysical simulations are performed on the initial thick cross-section and total porosity is calculated. The total porosity may be determined according to suitable algorithms for determining porosity based upon information associated with the cell grids in the thick cross-section or examination window. An example algorithm for computing the rock properties, including porosity, in a subset of cells belonging to the geocellular grid based on the data available in the full scale 3D geocellular model is the See-It-Now tool in the DecisionSpace® Earth modeling tool. Other suitable earth modeling algorithms, however, could be used which work with 3D geocellular models of oil and gas reservoirs.

In one or more embodiments, an REV will mimic the overall fluid conductivity and storage capability of petrophysical properties in the final full field static model. This allows using REV analysis to create a model that will honor the representative connectivity of the full field model, even though it is performed on a subset of the full field 3D geocellular model.

REV analysis may be performed on combined reconstructed images of porous media derived from computational tomography (CT). The REV analysis may be in the range of micro- or nanometer fields of view, but it may be extended to the case of a reservoir model, with reference to 50 to 100 meter scale cell sizes. The REV analysis should be performed to determine a smaller yet valid volume subset for further computation such that the measurements of fluid conductivity, pressure distribution, petrophysical property connectivity and absolute formation permeability resulting from numerical flow modeling in the thick cross-section has similar degrees of heterogeneity when compared to the measured permeability from larger reconstructed CT or scanning electron microscope (SEM) images. An example REV analysis may be found in Dvorkin, et al. “Relevance Of Computational Rock Physics, Geophysics, Vol. 76, No. 5, 2011. The determination of an REV is dependent on the geometry and the distribution of porosity in the subset model with respect to the full model. The REV analysis on the user-defined thick cross section also provides a mechanism for verifying other subset models based on fluid conductivity, property connectivity and/or absolute permeability.

After calculation of the total porosity for the initial cross-section in step 103 then, if the geometry of the thick cross section is still below a predetermined maximum size, as determined in step 103a, then the method iteratively increases the volume of the examination window by a predetermined number of cells on each side of the examination window in step 103b. Flow then proceeds back to step 103 and the method performs an REV analysis with respect to porosity for another iteration of the resulting thick cross section. The number of cells by which to increase the examination window after each iteration may be selected as a matter of design choice, as long as the total volume of the examination window continues to increase on each iteration. The volume of the examination window is iteratively increased and an REV analysis is determined until the examination window reaches a predetermined maximum geometry. The predetermined maximum geometry is also a matter of design choice, but it cannot exceed the size the of the full field model.

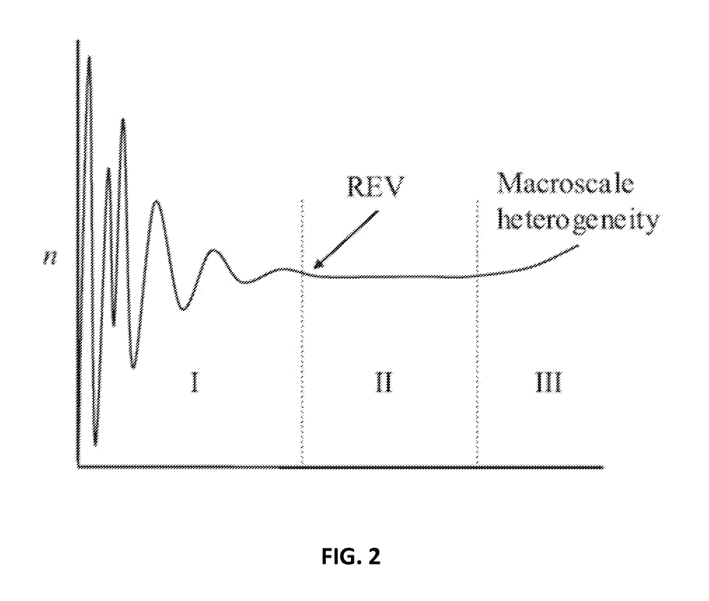

Once the thick cross section has reached a maximum size in step 103a, then flow proceeds to step 104, where an REV for the subset volume may be determined based on the porosity for the iteratively determined thick cross sections. FIG. 2 is a graph illustrating the relationship between porosity (n) and the volume of the examination window. As the volume of the examination window increases, the variations in porosity smooth out until the porosity for a given examination window becomes representative of similar volumes of the cells comprising the reservoir that make up the full scale model. The smallest volume that is representative of the porosity in the reservoir is the REV and may be determined from the example graph in FIG. 2 by finding the farthest left point, i.e., the smallest volume, at which the porosity becomes homogenous.

In one or more embodiments, the REV may be determined by referencing a display created by reproducing the graph on a computer display or a print out. With reference to the example graph shown in FIG. 2, it is seen that the REV becomes homogenous at the transition between regions I and II depicted in the figure. As the thick cross section is increased in volume throughout region II, it can be seen that the porosity remains substantially constant.

In other embodiments, the REV may be determined mathematically by, for example, applying a convergence analysis to the porosities determined through the iterations of the examination windows.

In step 105, the method may include determining potentially disparate REVs for each petrophysical realization. This allows comparison between the porosity determined by REV analysis and other, equal probable realizations of porosity, that may be determined using, for instance, stochastic analysis or determinative analysis, such as interpolations. By comparing these determinations of porosity with the porosity determined through REV analysis, the method may provide an REV that will more closely honor the statistics for the full field model.

In step 106, the method may allow the computation of permeability, which may be compared to the measured formation permeability. This allows verification of the REV determination, according to embodiments of the disclosure. By using the determined porosity to compute permeability, and then comparing this to measured formation permeability, a higher degree of confidence in the computed porosity may be obtained. An example tool for computing the formation fluid conductivity is Nexus™, available from Halliburton Energy Services, Inc.

One or more embodiments provide a method for determining a subset volume in a 3D geocellular model of an oil and gas reservoir. The method includes creating a 3D geocellular grid of the reservoir, defining a thick cross section for an area of interest within the 3D geocellular grid, the thick cross section having a predetermined initial number of cells, determining the porosity for the thick cross section, iteratively increasing the volume of the thick cross section by a predetermined number of cells on each side and determining the porosity for the resulting thick cross section until the thick cross section reaches a predetermined maximum geometry, (if spatial continuity of the thick cross section is not restricted by explicit inclusion of selected wells in the reservoir model) moving the examination window to systematic disparate locations in addition to growing the thick cross section and performing a representative elemental volume (REV) analysis with respect to porosity for the resulting thick cross section.

In other embodiments, a 3D geocellular oil and gas modeling system is provided. The system may include a computer processor, a storage medium accessible by the computer processor containing data reflecting an oil and gas reservoir, including well locations and data reflecting the rock properties of wells in the oil and gas reservoir, a 3D geocellular grid of the reservoir, a thick cross section for an area of interest within the 3D geocellular grid having a predetermined initial number of cells, and a set of instructions formed thereon that, when executed, cause the processor to perform a plurality of actions. These actions include determining the porosity for the thick cross section, iteratively increasing the volume of the thick cross section by a predetermined number of cells on each side and determining the porosity for the resulting thick cross section until the thick cross section reaches a predetermined maximum geometry, (if spatial continuity of the thick cross section is not restricted by explicit inclusion of selected wells in the reservoir model) moving the examination window to systematic disparate locations in addition to growing the thick cross section and generating a display reflecting a representative elemental volume (REV) with respect to porosity for the resulting thick cross section.

In further embodiments, a computer readable medium is provided. The medium may have a set of instructions for determining a subset volume in a 3D geocellular model of an oil and gas reservoir, wherein, when executed by a computer processor, the instructions cause the processor to perform a plurality of actions. These actions may include creating a 3D geocellular grid of the reservoir defining a thick cross section for an area of interest within the 3D geocellular grid, the thick cross section having a predetermined initial number of cells, determining the porosity for the thick cross section, iteratively increasing the volume of the thick cross section by a predetermined number of cells on each side and determining the porosity for the resulting thick cross section until the thick cross section reaches a predetermined maximum geometry, (if spatial continuity of the thick cross section is not restricted by explicit inclusion of selected wells in the reservoir model) moving the examination window to systematic disparate locations in addition to growing the thick cross section and generating a display reflecting a representative elemental volume (REV) with respect to porosity for the resulting thick cross section.

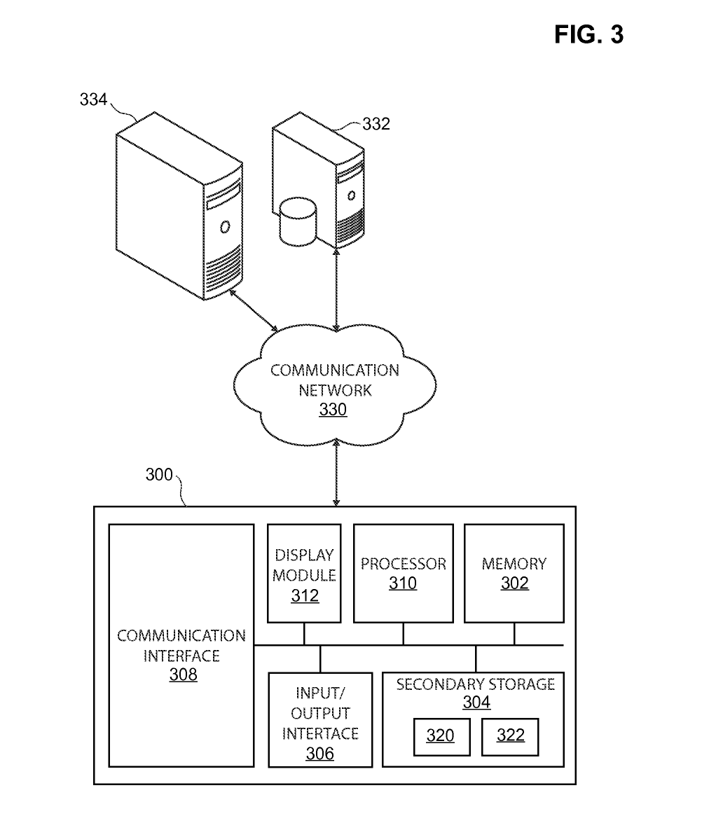

FIG. 3 is a block diagram illustrating one embodiment of a system 300 for implementing the features and functions of the disclosed embodiments. The system 300 may be any type of computing device such as, but not limited to, a personal computer, a server system, a client system, a laptop, a tablet, and a smartphone. The system 300 includes, among other components, a processor 310, main memory 302, secondary storage unit 304, an input/output interface module 306, and a communication interface module 308. The processor 310 may be any type or any number of single core or multi-core processors capable of executing instructions for performing the features and functions of the disclosed embodiments.

The input/output interface module 306 enables the system 300 to receive user input (e.g., from a keyboard and mouse) and output information to one or more devices such as, but not limited to, printers, external data storage devices, and audio speakers. The system 300 may optionally include a separate display module 312 to enable information to be displayed on an integrated or external display device. For instance, the display module 312 may include instructions or hardware (e.g., a graphics card or chip) for providing enhanced graphics, touchscreen, and/or multi-touch functionalities associated with one or more display devices.

Main memory 302 is volatile memory that stores currently executing instructions/data or instructions/data that are prefetched for execution. The secondary storage unit 304 is non-volatile memory for storing persistent data. The secondary storage unit 304 may be or include any type of data storage component such as a hard drive, a flash drive, or a memory card. In one embodiment, the secondary storage unit 304 stores the computer executable code/instructions and other relevant data for enabling a user to perform the features and functions of the disclosed embodiments.

For example, in accordance with the disclosed embodiments, the secondary storage unit 304 may permanently store the executable code/instructions associated with a casing design application 320 for performing the above-described methods. The instructions associated with the casing design algorithm 320 are loaded from the secondary storage unit 304 to main memory 302 during execution by the processor 310 for performing the disclosed embodiments.

The communication interface module 308 enables the system 300 to communicate with the communications network 330. For example, the network interface module 308 may include a network interface card and/or a wireless transceiver for enabling the system 300 to send and receive data through the communications network 330 and/or directly with other devices.

The communications network 330 may be any type of network including a combination of one or more of the following networks: a wide area network, a local area network, one or more private networks, the Internet, a telephone network such as the public switched telephone network (PSTN), one or more cellular networks, and wireless data networks. The communications network 330 may include a plurality of network nodes (not depicted) such as routers, network access points/gateways, switches, DNS servers, proxy servers, and other network nodes for assisting in routing of data/communications between devices.

For example, in one embodiment, the system 300 may interact with one or more servers 334 or databases 332 for performing the features of the present invention. For instance, the system 300 may query the database 332 to obtain well data for updating the three dimensional tunnel view of the operating envelope in real-time in accordance with the disclosed embodiments. Further, in certain embodiments, the system 300 may act as a server system for one or more client devices or a peer system for peer to peer communications or parallel processing with one or more devices/computing systems (e.g., clusters, grids).

In some embodiments, the method may further comprise any one of the following features individually or any two or more of these features in combination: (a) wherein performing an REV analysis comprises comparing the porosity with the size of the thick cross section and determining the minimum size of the thick cross section that exhibits a homogenous porosity, (b) wherein determining the minimum size of the thick cross section comprises applying a convergence analysis, (c) wherein the thick cross section is defined in void space, (d) wherein the predetermined maximum geometry is determined by a geocellular volume for the thick cross section that encompasses specifically identified wells in the reservoir, (e) wherein the predetermined maximum geometry is determined by a specified number of wells to be encompassed by the thick cross section, and (f) wherein the thick cross section acts as an examination window (excluding spatial well location constraints) moveable within the geocellular grid.

In some embodiments, the system may further comprise any one of the following features individually or any two or more of these features in combination: (a) wherein generating a display reflecting an REV comprises comparing the porosity with the size of the thick cross section and determining the minimum size of the thick cross section that exhibits a homogenous porosity, (b) wherein determining the minimum size of the thick cross section comprises performing a convergence analysis, (c) wherein the thick cross section is defined in void space, (d) wherein the predetermined maximum geometry is determined by a geocellular volume for the thick cross section that encompasses specifically identified wells in the reservoir, (e) wherein the predetermined maximum geometry is determined by a specified number of wells to be included in the thick cross section, (f) wherein the thick cross section acts as an examination window (excluding spatial well location constraints) moveable within the geocellular grid.

In some embodiments, the computer readable medium may further comprise any one of the following features individually or any two or more of these features in combination: (a) wherein generating a display reflecting a representative elemental volume requires performing an REV analysis which comprises comparing the porosity of the thick cross section and determining the minimum size of the thick cross section that exhibits a homogenous porosity, (b) wherein determining the minimum size of the thick cross section comprises applying a convergence analysis, (c) wherein the thick cross section is defined in void space, (d) wherein the predetermined maximum geometry is determined by a geocellular volume for the thick cross section that encompasses specifically identified wells in the reservoir, (e) wherein the predetermined maximum geometry is determined by a specified number of wells to be encompassed by the thick cross section and (f) wherein the thick cross section acts as an examination window (excluding spatial well location constraints) moveable within the geocellular grid.

While the disclosed embodiments have been described with reference to one or more particular implementations, those skilled in the art will recognize that many changes may be made thereto without departing from the spirit and scope of the description. Accordingly, each of these embodiments and obvious variations thereof is contemplated as falling within the spirit and scope of the claims.

What is claimed is:

1. A method for determining a subset volume in a 3D geocellular model of an oil and gas reservoir comprising:
creating a 3D geocellular grid of the reservoir;
defining a thick cross section for an area of interest within the 3D geocellular grid, the thick cross section having a predetermined initial number of cells;
determining the porosity for the thick cross section;
iteratively increasing the volume of the thick cross section by a predetermined number of cells on each side and determining the porosity for the resulting thick cross section until the thick cross section reaches a predetermined maximum geometry; and
performing a representative elemental volume (REV) analysis with respect to porosity for the resulting thick cross section.

2. A method as in claim 1, wherein performing an REV analysis comprises comparing the porosity with the size of the thick cross section and determining the minimum size of the thick cross section that exhibits a porosity distribution which is representative of the full model.

3. A method as in claim 2, wherein determining the minimum size of the thick cross section comprises applying a convergence analysis.

4. A method as in claim 1, wherein the thick cross section is defined in void space.

5. A method as in claim 1, wherein the predetermined maximum geometry is determined by a geocellular volume for the thick cross section that does not encompass specifically identified well locations in the reservoir.

6. A method as in claim 1, wherein the predetermined maximum geometry is determined by a specified number of wells to be encompasses by the thick cross section.

7. A method as in claim 5, wherein the thick cross section acts as an examination window moveable within the geocellular grid by a predetermined number of cells.

8. A 3D geocellular oil and gas modeling system comprising:
a computer processor;
a storage medium accessible by the computer processor containing data reflecting an oil and gas reservoir, including well locations and data reflecting the rock properties of wells in the oil and gas reservoir, a 3D geocellular grid of the reservoir, a thick cross section for an area of interest within the 3D geocellular grid having a predetermined initial number of cells, and a set of instructions formed thereon that, when executed, cause the processor to perform a plurality of actions including:
determining the porosity for the thick cross section,
iteratively increasing the volume of the thick cross section by a predetermined number of cells on each side and determining the porosity for the resulting thick cross section until the thick cross section reaches a predetermined maximum geometry, and
generating a display reflecting a representative elemental volume (REV) with respect to porosity for the resulting thick cross section.

9. A system as in claim 1, wherein generating a display reflecting an REV comprises comparing the porosity with the size of the thick cross section and determining the minimum size of the thick cross section that exhibits a homogenous porosity.

10. A system as in claim 9, wherein determining the minimum size of the thick cross section comprises performing a convergence analysis.

11. A system as in claim 8, wherein the thick cross section is defined in void space.

12. A system as in claim 8, wherein the predetermined maximum geometry is determined by a geocellular volume for the thick cross section that encompasses specifically identified wells in the reservoir.

13. A system as in claim 8, wherein the predetermined maximum geometry is determined by a specified number of wells to be encompassed by the thick cross section.

14. A system as in claim 13, wherein the thick cross section acts as an examination window moveable within the geocellular grid.

15. A computer readable medium having a set of instructions for determining a subset volume in a 3D geocellular model of an oil and gas reservoir, wherein, when executed by a computer processor, the instructions cause the processor to perform a plurality of actions including:
creating a 3D geocellular grid of the reservoir;
defining a thick cross section for an area of interest within the 3D geocellular grid, the thick cross section having a predetermined initial number of cells;
determining the porosity for the thick cross section;
iteratively increasing the volume of the thick cross section by a predetermined number of cells on each side and determining the porosity for the resulting thick cross section until the thick cross section reaches a predetermined maximum geometry; and
generating a display reflecting a representative elemental volume (REV) with respect to porosity for the resulting thick cross section.

16. A computer readable medium as in claim 15, wherein generating a display reflecting a representative elemental volume further comprises performing an REV analysis comprises comparing the porosity with the size of the thick cross section and determining the minimum size of the thick cross section that exhibits a homogenous porosity.

17. A computer readable medium as in claim 16, wherein determining the minimum size of the thick cross section comprises applying a convergence analysis.

18. A computer readable medium as in claim 15, wherein the thick cross section is defined in void space.

19. A computer readable medium as in claim 15, wherein the predetermined maximum geometry is determined by a geocellular volume for the thick cross section that encompasses specifically identified wells in the reservoir.

20. A computer readable medium as in claim 15, wherein the predetermined maximum geometry is determined by a specified number of wells to be encompassed by the thick cross section and the thick cross section acts as an examination window moveable within the geocellular grid.
